(19) United States
(12) Patent Application Publication
(10) Pub. No.: US 2006/0063668 A1
(43) Pub. Date: Mar. 23, 2006

(54) Visible-light-activated photocatalyst and method for producing the same

(75) Inventors: Yao-Hsuan Tseng, Taoyuan County (TW); Chien-Sheng Kuo, Tainan County (TW); Yu-Ming Lin, Hsinchu County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 11/019,384

(22) Filed: Dec. 23, 2004

(30) Foreign Application Priority Data
Sep. 22, 2004 (TW) 93128677

(51) Int. Cl. B01J 21/06

(52) U.S. Cl. 502/350

(57) ABSTRACT

A photocatalyst powder and the method of chemical vapor deposition for producing the same are provided. Titanium salt is injected into a chamber by the carrier gas. After reaction with oxygen gas, the photocatalyst particle is introduced to a low temperature collection device. The synthesized titanium dioxide powder is nano-sized, well-dispersed and anatase-crystallinity. The air contaminant was degraded with this photocatalyst under 315 nm to 700 nm irradiation. The method enhances the conversion of sunlight irradiation to chemical energy.

### BACKGROUND OF THE INVENTION

1. Field of the Invention

The present invention relates to a method for preparing photocatalyst, specifically a method of chemical vapor deposition for preparing visible-light-activated titanium dioxide photocatalyst nanoparticles.

2. Description of the Related Art

Nanomaterials are materials with size ranging from 1 nm to 100 nm. Given their tiny dimensions, nanomaterials exhibit many properties, for example, electrical, thermal, magnetic and optical properties, different from those of larger sized materials. Nanotechnology is a technology for preparing a nanomaterial using direct or indirect methods to manipulate atoms or molecules, and applying the nanomaterial in various fields. Nanomaterials come in a wide variety and cover the fields of semiconductor, metal, polymer, biomedicine, carbon tube, etc. Nanomaterials are typically measured by their electrical, optical, magnetic, thermal and chemical properties. The wonderful characteristics of nanomaterials are also applicable to industrial catalyst to enhance the surface area of the catalyst. The doping of nanomaterial can also be used to enhance the mechanical strength of devices. Turning semiconductor materials into nanosize can create high quantum confinement of electron and hole to increase the illumination efficiency and breakdown temperature of semiconductor laser. The availability of nanosized semiconductor can further reduce the size of optical and electrical components. Nanotechnology will make the integration of electronic, optical, magnetic and bio components possible.

Titania (titanium dioxide, TiO₂) nanoparticles as photocatalyst have been extensively used to improve our living environment and gradually accepted by the consumer public. Titanium dioxide photocatalyst possesses anatase structure with grain size under 30nm. Under ultraviolet light irradiation (wavelength under 388 nm), active substance is produced on the surface of titania particle which can oxidize or reduce the pollutants. In addition, because oxygen atoms are detached from the surface, the photocatalyst becomes highly hydrophilic, thus possessing anti-fog, anti-dust and other self-cleaning functions. Titanium dioxide photocatalyst has been used extensively for pollutant removal, air cleansing, water purification, odor removal, anti-septic, anti-dust and anti-fog purposes. Doped photocatalyst with light source from fiber optic is found to inhibit the growth of cancer cells or even kill cancer cells.

The most commonly employed method for preparing titanium dioxide photocatalyst powder is sol-gel method. But such method requires the front-end processes of agitation and mixing of reaction solutions, hydrolysis and condensation, prolonged, and thermostatic drying of precipitate, as well as the back-end process of high-temperature calcination. The whole process is not only tedious and time-consuming, more so, it allows only batch production that produces limited output and fails to satisfy the needs for continuous mass production.

There are papers relating to the use of chemical vapor deposition (CVD) for the production of photocatalyst film, which however did not mention the production of powder form product or the technology that renders the resulting photocatalyst visible light sensitive. There are also propositions for combining CVD and plasma modification method to produce visible-light-activated photocatalyst. In comparison with prior art, this invention does not require plasma which consumes large amount of energy for the production of visible-light-activated photocatalyst and the resulting titanium dioxide photocatalyst allows more efficient use of solar energy.

### SUMMARY OF THE INVENTION

To address the drawbacks of prior arts about preparation of photocatalyst powder by sol-gel method, the present invention discloses a method for preparing nano-sized, well-dispersed titanium dioxide photocatalyst powder with anatase crystallinity under controlled conditions by means of chemical vapor deposition, which exhibits excellent catalytic activity under UV light and visible light irradiation.

The present invention is to provide a method for preparing visible-light-activated titanium dioxide photocatalyst nanoparticles, comprising the steps of: providing a reaction chamber; raising the temperature of reaction chamber to 500° C.˜1000° C. and vacuuming the chamber to below 20 torr; feeding a carrier gas and an oxygen-containing gas into the reaction chamber; injecting titanium salt into the chamber by carrier gas to let it react with the oxygen-containing gas; collecting the resulting titanium dioxide photocatalyst powder with a low-temperature collection device to prevent the powder from further precipitation.

In a preferred embodiment of the invention, the aforesaid preparation method may further contain a step of purging gases in the reaction chamber with carrier gas.

The present invention is to provide titanium dioxide photocatalyst nanoparticles prepared according to the method disclosed herein, wherein the photocatalyst nanoparticles have anatase crystallinity and grain size under 20 nm, contain less than 2% carbon atoms, and exhibit photocatalytic activity under ultraviolet light irradiation (wavelength <365 nm) and visible light irradiation (wavelength range from 365 nm to 700 nm).

Moreover, the present invention is to provide an apparatus for producing visible-light-activated titanium dioxide photocatalyst nanoparticles, comprising: a reaction chamber to provide an environment for the production of titanium dioxide photocatalyst nanoparticles by chemical vapor deposition; a temperature control unit to control the temperature of the reaction chamber; a mass-flow control unit, which is connected to the reaction chamber for feeding carrier gas, oxygen-containing gas, and titanium salt needed for the reaction; a vacuum pump to provide the reaction chamber with negative pressure; and a low-temperature collection device, which is connected to the reaction chamber and vacuum pump to cool and collect the resulting titanium dioxide photocatalyst powder from the reaction chamber so as to prevent the powder from further aggregation.

Using the apparatus and method provided in the invention for preparing titanium dioxide photocatalyst powder involves simple steps, saves time, and achieves the goal of continuous production. Literature shows that the titanium dioxide in anatase phase performs better as a photocatalyst than in rutile phase. Titanium dioxide powder produced by chemical vapor deposition typically has mixed anatase-rutile phase, which adversely affects its photocatalytic effect. The method disclosed herein is able to produce photocatalyst nanoparticles with excellent anatase crystallinity by controlling precisely the synthesis temperature. Typical liquid phase processes for the preparation of photocatalyst involves complicated and time-consuming steps of hydrolysis, condensation, drying and calcinations. In comparison, the method disclosed herein is free of many subsequent procedures, thereby saving the production time. More so, the photocatalyst produced according to the method disclosed herein is ultraviolet light and visible light sensitive. It can boost the use efficiency of solar energy and expands the application of photocatalyst.

### BRIEF DESCRIPTION OF THE DRAWINGS

FIG. 1 shows the diagram of apparatus for preparing titanium dioxide photocatalyst nanoparticles according to the invention.

FIG. 2 shows the flow chart for preparing titanium dioxide photocatalyst nanoparticles according to the invention.

FIG. 3 shows the SEM photo of titanium dioxide photocatalyst nanoparticles prepared and collected by low-temperature collection device according to the invention.

FIG. 4 shows the SEM photo of titanium dioxide photocatalyst nanoparticles prepared, but not collected by low-temperature collection device according to the invention.

FIG. 5 shows the XRD graph of titanium dioxide photocatalyst nanoparticles prepared according to the invention.

FIG. 6 shows the XPS graph of titanium dioxide photocatalyst nanoparticles prepared according to the invention.

FIG. 7 shows the photocatalytic activity test chart of titanium dioxide photocatalyst nanoparticles prepared according to the invention.

### DETAILED DESCRIPTION OF THE INVENTION

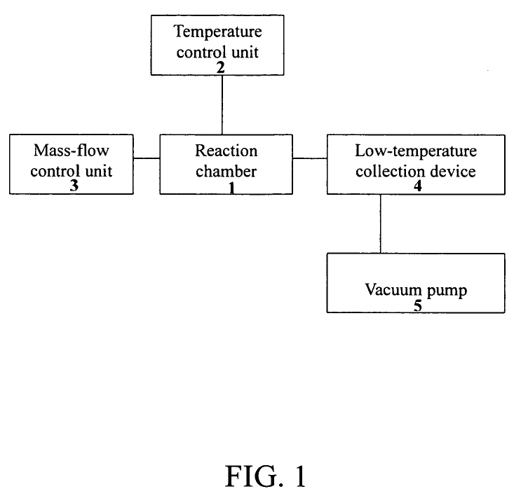

The apparatus for preparing visible-light-activated titanium dioxide photocatalyst nanoparticles by chemical vapor deposition according to the present invention as shown in FIG. 1 comprises: a reaction chamber 1; a temperature control unit 2; a mass-flow control unit 3; a low-temperature collection device 4; and a vacuum pump 5. In light that chemical vapor deposition must be carried out under high temperature and in vacuum state, the reaction chamber 1 must be able to withstand such conditions. In the embodiment, the reaction chamber 1 is quartz tube that is resistant to high temperature and vacuum, and the high temperature needed for the reaction is obtained by heating the quartz tube in a high-temperature oven (i.e. the temperature control unit 2). A concrete example of mass-control unit 3 is a plurality of pipes with regulating valves which are connected to the inlet of reaction chamber 1 where carrier gas, oxygen-containing gas and titanium salt needed by the chemical vapor deposition reaction are fed into the reaction chamber through the plurality of pipes, while the flow of reactants or carrier is regulated by the regulating valves.

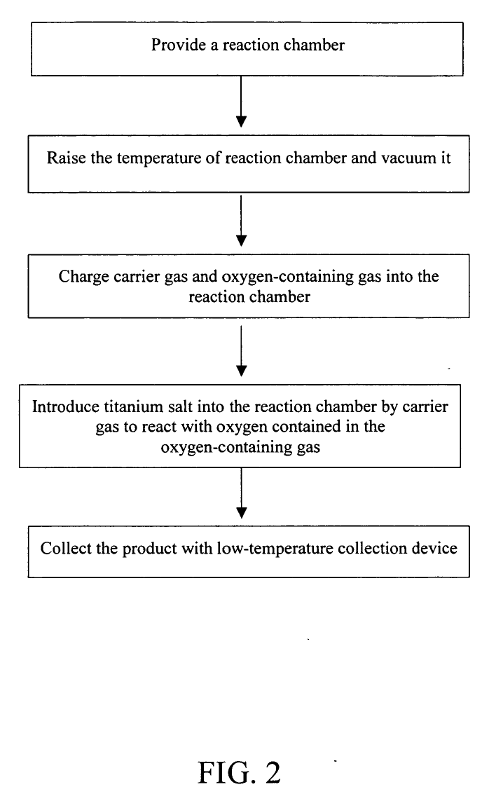

The method for preparing titanium dioxide photocatalyst powder according to the invention as depicted in FIG. 2 is described below accompanied by the apparatus illustrated in FIG. 1: First provide a reaction chamber 1, then raise the temperature of chamber and vacuum it. This is achieved by using temperature control unit 2 to raise the temperature of reaction chamber 1 to 500° C.˜1000° C., preferably to 500° C.˜800° C., and at the same time, extract air in the chamber with vacuum pump 5 to below 20 torr to keep the reaction chamber 1 and low-temperature collection device 4 in vacuum state during the process of operation. Also at the same time of heating the reaction chamber, charge carrier gas into the reaction chamber 1 through mass-flow control unit to purge excess gas. Inert gas, such as nitrogen, argon and helium that will not be involved in the chemical vapor deposition reaction is selected as carrier gas. The mass-flow control unit 3, constituted by a plurality of pipes and regulating valves, controls the charging and feed amount of carrier gas as well as oxygen-containing gas and titanium salt into the reaction chamber 1. When the temperature and torr in reaction chamber 1 reach reaction conditions, oxygen-containing gas is fed into the chamber through mass-flow control unit 3. The titanium salt and oxygen in the oxygen-containing gas will react in the reaction chamber 1 to form titanium dioxide powder. The titanium salt used is selected from Ti[OCH₂CH(C₂H₅)(CH₂)₃CH₃]₄, [CH₃CH(O)CO₂NH₄] ₂Ti(OH)₂, Ti[RCH₂(C₂H₅)CH(R′)C₃H₇]₄, or alkoxy titanium having a structural formula of Ti(OR″)₄, where R and R′ are O or OH, R″ is CₙH₂ₙ₊₁, n=2˜15. As reaction carries on, the titanium dioxide powder would collide and aggregate continuously to form larger particles. To prevent such phenomenon, the reaction chamber 1 is kept under negative pressure by vacuum pump 5 to provide an environment ideal for chemical vapor deposition and to carry the titanium dioxide powder formed in the reaction chamber 1 away from the chamber as soon as possible to low-temperature collection device 4, where the powder is cooled and collected. In the embodiment, water-cooled collection device is used. To make sure the low-temperature collection device works properly, cooling water below 5° C. is sent into the collection device to cool the collected titanium dioxide powder rapidly and keep them from aggregating. In addition, the collection device 4 cools the titanium dioxide powder at anatase phase to prevent it from converting to rutile phase.

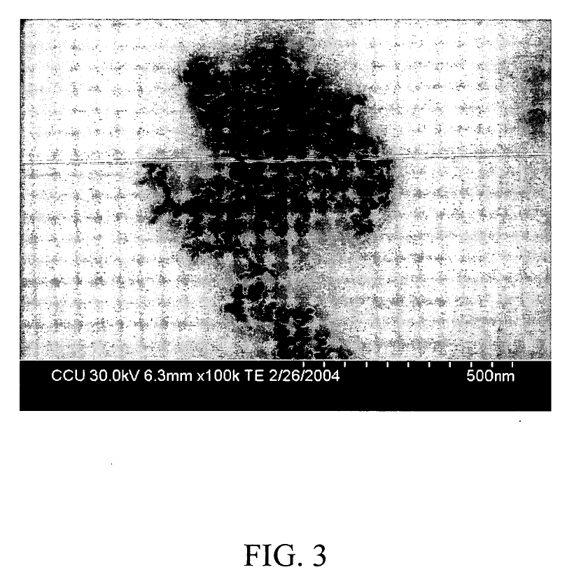

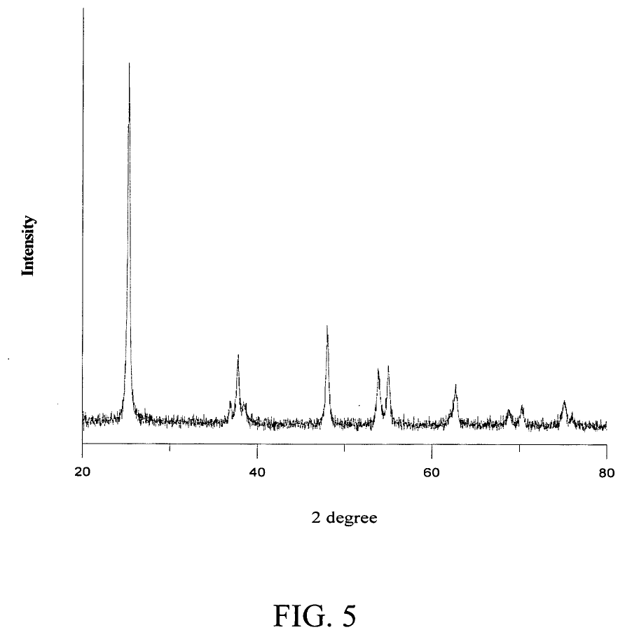

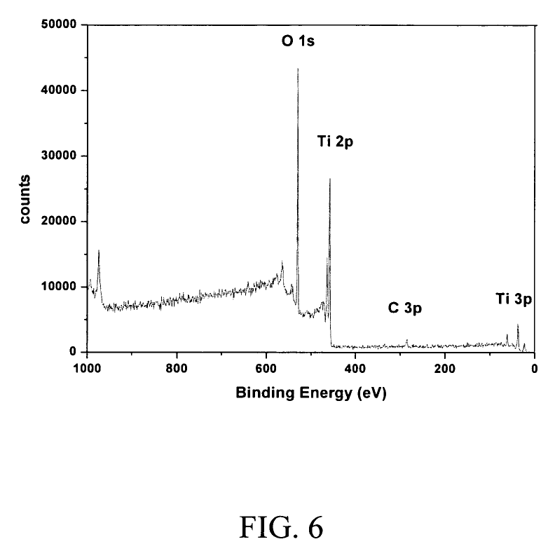

The titanium dioxide powder prepared by the method of chemical vapor deposition as disclosed herein exhibits photcatalytic activity under both ultraviolet light and visible light. Its gain size as shown in FIG. 3 ranges from 5 to 20 nm, and it has anatase crystallinity as shown in the XRD graph in FIG. 5. From the XPS graph in FIG. 6, one can tell that titanium dioxide powder of the present invention contains less than 2% carbon atoms.

The features and advantages of the present invention are further depicted in the illustration of examples, but the descriptions made in the examples should not be construed as a limitation on the actual application of the present invention.

### EXAMPLE 1

### Preparation of Visible-Light-Activated TiO₂ Photocatalyst Powder by Chemical Vapor Deposition (CVD)

First raise the temperature of quartz tube used as reaction chamber to 700° C., and in the process of heating, keep the pressure in the reaction chamber under 10 torr with a pump, and charge 40 sccm nitrogen gas into the quartz tube to purge excess gas. When the temperature of quartz tube reaches 700° C., adjust the constant feed of oxygen gas into the quartz tube to 200 sccm and introduce cooling water below 5° C. into the low-temperature collection device; then feed alkoxy titanium into the quartz tube at the rate of 1 ml/min using nitrogen as carrier gas. The alkoxy titanium reacts with oxygen in the 700° C. quartz tube to form titanium dioxide powder. Next use the negative pressure provided by the pump to remove the titanium dioxide powder from the reaction chamber into the low-temperature collection device with cooling water below 5° C. passing through.

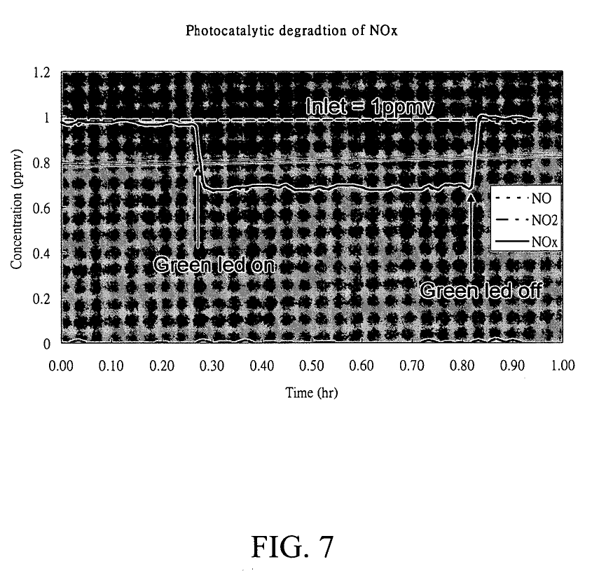

FIG. 7 shows the photocatalytic activity of the prepared TiO₂ powder as tested under green LED lamp. In the test, JIS R 1701-1 test method was followed with regard to NOx degradation system and the resulting by-products are observed. Table 1 depicts the degradation of NOx by the titanium dioxide powder herein and its NO₂ production rate under different wavelengths. NO₂ is much more toxic than NO where the threshold limit value of NO is 3 ppm and that of NO₂ is 25 ppm. If the by-products of the photocatalytic reaction are more toxic, the applicability of the photocatalyst will be adversely affected.

As shown by FIG. 7 and Table 1, the prepared TiO₂ powder could still degrade NO effectively under the irradiation of visible light 500-600 nm, and under different wavelengths, the concentration of NO₂ will not change as the wavelength increases, which effectively prevents the production of secondary pollutants and achieves the effect of pollutant removal with visible light.

TABLE 1
Production of NO₂ by TiO₂ powder according to the invention under
irradiation of different wavelengths; NO feed concentration: 1 ppmv,
flow rate: 1 L/min; RH: 9%; powder amount: 0.5 g; illumination:
1 mW/cm²; NO₂ production: ppm

| | Wavelength | | |
|---|---|---|---|
| | UVA lamp | Blue LED lamp | Green LED lamp |
| Powder | 315-400 nm | 435-500 nm | 500-600 nm |
| TiO₂ powder prepared | 0.04 ppm | 0.01 ppm | 0.01 ppm |
| in Example 1 | | | |

### COMPARATIVE EXAMPLE 1

### Comparing the NO Degradation Activity of TiO₂ Powder According to the Invention Under Visible Light with Other Commercial TiO₂ Catalysts

This example demonstrates the photocatalytic effect of TiO₂ powder according to the invention as compared to other photocatalyst products through the test NOx degradation. In the test, NO at the concentration of 1 ppmv was taken as the standard for pollutant removal. JIS R 1701-1 test method was followed with regard to NOx degradation system. The light source for the test included UVA lamp (315-400 nm), blue LED lamp (435-500 nm), and green LED lamp (500-600 nm). Photocatalysts used for comparison included photocatalyst powder prepared under 500° C. according to the invention, and three commonly seen TiO2 photocatalysts on the market: Hombikat UV100, Ishihara STOI, and Degussa P25. The results are as shown in Table 2.

TABLE 2
Comparing the NOₓ removal effect of commercial TiO₂
photocatalysts with TiO₂ powder prepared according to the
present invention; NO feed concentration: 1 ppmv, flow rate: 1 L/min;
RH: 9%; powder amount: 0.5 g; illumination: 1 mW/cm²;
removal rate: %

| | Wavelength | | |
|---|---|---|---|
| | UVA lamp | Blue LED lamp | Green LED lamp |
| Powder | 315-400 nm | 435-500 nm | 500-600 nm |
| UV 100 | 58% | 35% | 5% |
| ST01 | 60% | 33% | 5% |
| P25 | 55% | 30% | 3% |
| Powder made in | 65% | 46% | 39% |
| Example 1 | | | |

From Table 2, it is clear that the effect of TiO₂ photocatalyst of the present invention on NOx degradation under the irradiation of insect catching lamp (315 nm˜400 nm) is comparable to that of commercial TiO₂ powders. Under the irradiation of blue LED lamp (435 nm˜500 nm), the NOx degradation effect of TiO₂ photocatalyst of the present invention is 1.5 times better than that of commercial powders. When green LED lamp (500 nm˜600 nm) is used, the effect is more than 7 times stronger than that of commercial photocatalysts. It can be concluded that the photocatalyst of the present invention performs better than commercial photocatalysts. Given that visible light has wider wavelength range than ultraviolet light in the solar energy spectrum, the photocatalyst powder of the present invention can absorb solar energy more effectively to convert it into chemical energy in actual application.

### COMPARISON EXAMPLE 2

### Comparing the NO Degradation Activity of TiO₂ Powders Prepared According to the Invention Under Different Vapor Deposition Temperature

This example compares the photocatalytic activity of TiO₂ photocatalysts prepared according to the invention under different vapor deposition temperature from 500° C. to 1000° C. From Table 3, we can see that powder prepared under 800° C. and irradiated by UV light provides the best NO removal rate of 80%, while powders prepared under 600-700° C. and irradiated by blue LED lamp have 50% removal rate, and powder prepared under 500° C. and irradiated by green LED lamp has close to 40% removal rate. When the temperature of reaction chamber ranges between 500-800° C., the prepared photocatalysts exhibit better NO degradation activity under the irradiation of both visible light and UV light, while the effect of photocatalysts prepared under 1000° C. under the irradiation of inspect-catching lamp and blue LED lamp is comparable to that of commercial photocatalysts, but better than commercial photocatalysts under the irradiation of green LED lamp. But if the temperature of reaction chamber exceeds 1000° C., the resulting powder will have larger grain size and less effective carbon atoms, thereby losing its photocatalytic activity.

TABLE 3
Comparing the NO degradation effect of TiO₂ photocatalysts
prepared under different vapor deposition temperature according to
the present invention; NO feed concentration: 1 ppmv, flow rate: 1 L/
min; RH: 9%; powder amount: 0.5 g; illumination: 1 mW/cm²;
removal rate: %

| | Wavelength | | |
|---|---|---|---|
| Preparation | UVA lamp | Blue LED lamp | Green LED lamp |
| condition | 315-400 nm | 435-500 nm | 500-600 nm |
| 500° C. | 65% | 46% | 39% |
| 600° C. | 70% | 52% | 23% |
| 700° C. | 75% | 50% | 20% |
| 800° C. | 80% | 46% | 16% |
| 900° C. | 74% | 44% | 13% |
| 1000° C. | 56% | 30% | 13% |
| ST01 | 60% | 33% | 5% |

### COMPARISON EXAMPLE 3

### Comparing the NOx Removal Activity of TiO₂ Powders Collected and Not Collected with a Low-Temperature Collection Device During Preparation According to the Present Invention

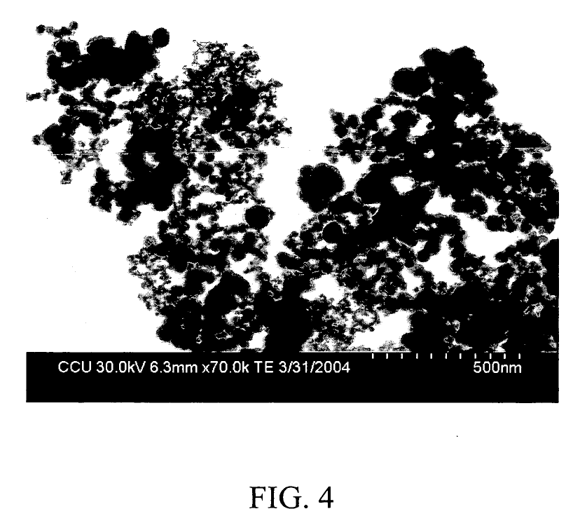

In this example, TiO₂ powders were prepared under the deposition temperature of 500° C., but one group used a low-temperature collection device and the other group was collected directly without the cooling process. Table 4 shows the NOx removal activities of the resulting powders. FIG. 3 is the SEM photo of photocatalyst powder collected by low-temperature collection device, and FIG. 4 is the SEM photo of photocatalyst powder collectedly directly without the use of low-temperature collection device. It is clear that the TiO₂ powders in FIG. 4 aggregate into particles 100-500 nm in size and are markedly larger than those in FIG. 3, while not as well dispersed. It is also found in Table 4 that in the range of either visible light or UV light, the activity of powders that were cooled and collected is far better than that of directly collected powders. Under UV light, the disparity in activity amounts to five times, while under visible light, uncooled powders exhibit nearly no photocatalytic activity, suggesting that the use of low-temperature collection device in the preparation of photocatalyst powder is an important step.

TABLE 4
Comparing the NOₓ removal effect of TiO₂ powders
prepared with or without the use of low-temperature collection device
according to the present invention; NO feed concentration: 1 ppmv,
flow rate: 1 L/min; RH: 9%; powder amount: 0.5 g;
illumination: 1 mW/cm²; removal rate: %

| | Wavelength | | |
|---|---|---|---|
| | UVA lamp | Blue LED lamp | Green LED lamp |
| Powder | 315-400 nm | 435-500 nm | 500-600 nm |
| Directly collected | 12% | 3% | 2% |
| powder | | | |
| Powder collected with | 65% | 52% | 39% |
| low-temperature | | | |
| collection device | | | |

### Other Embodiments

The embodiments of the present invention have been disclosed in the examples. All modifications and alterations without departing from the spirits of the invention and appended claims, including the other embodiments shall remain within the protected scope and claims of the invention.

What is claimed is

1. A method for preparing visible-light-activated titanium dioxide photocatalyst nanoparticles, comprising the steps of:
providing a reaction chamber;
raising the temperature of reaction chamber to 500° C.˜1000° C. and vacuuming the chamber to below 20 torr;
feeding a carrier gas and an oxygen-containing gas into the reaction chamber;
introducing titanium salt into the chamber by carrier gas to let it react with the oxygen-containing gas; and
collecting the resulting titanium dioxide photocatalyst nanoparticles with a low-temperature collection device to prevent the powder from further precipitation.

2. The method according to claim 1, wherein said reaction chamber is quartz tube.

3. The method according to claim 1, wherein the temperature of said reaction temperature ranges from 500° C. to 800° C.

4. The method according to claim 1, wherein the torr in the reaction cahmber is below 10 torr.

5. The method according to claim 1, wherein said carrier gas is nitrogen, argon or helium.

6. The method according to claim 5, wherein said carrier gas is nitrogen.

7. The method according to claim 1, wherein said oxygen-containing gas is oxygen or air.

8. The method according to claim 7, wherein said oxygen-containing gas is oxygen.

9. The method according to claim 1, wherein said titanium salt contains Ti[OCH₂CH(C₂H₅)(CH₂)₃CH₃]₄, [CH₃CH(O)CO₂NH₄]₂Ti(OH)₂, or Ti[RCH₂(C₂H₅)CH(R′)C₃H₇]₄, wherein R and R′ are O or OH.

10. The method according to claim 1, wherein said titanium salt includes alkoxy titanium having a structural formula of Ti(OR″)₄, wherein R″ is CₙH₂ₙ₊₁, n=2˜15.

11. The method according to claim 1, wherein the method can further include a step of using carrier gas to purge the gases in the reaction cahmber.

12. A visible-light-activated titanium dioxide photocatalyst nanoparticles prepared according to the method described in claim 1, having anatase crystallinity, grain size under 20 nm and containing less than 2% carbon atoms, characterized in which it exhibits photocatalytic activity under ultraviolet light irradiation (wavelength <365 nm) and visible light irradiation (wavelength range from 365 nm to 700 nm).

13. An apparatus for producing titanium dioxide photocatalyst nanoparticles, comprising:
a reaction chamber to provide an environment for chemical vapor deposition;
a temperature control unit to control the temperature of said reaction chamber;
a mass-flow control unit, which is connected to the reaction chamber for feeding carrier gas, oxygen-containing gas, and titanium salt needed for the reaction;
a vacuum pump to provide the reaction chamber with negative pressure; and
a low-temperature collection device, which is connected to the reaction chamber and vacuum pump to cool and collect the resulting titanium dioxide photocatalyst powder from the reaction chamber so as to prevent the powder from further precipitation.

14. The apparatus according to claim 13, wherein said reaction chamber is quartz tube.

15. The apparatus according to claim 13, wherein said temperature control unit is a high-temperature oven.

16. The aparatus according to claim 13, wherein said mass-flow control unit comprises a plurality of pipes with regulating valves which introduce carrier gas, oxygen-containing gas and titanium salt into the reaction chamber with the flow regulated by the regulating valves.
